(19) United States
(12) Patent Application Publication
(10) Pub. No.: US 2006/0198156 A1
(43) Pub. Date: Sep. 7, 2006

(54) Multifunction mirror display

(76) Inventors: Jinfang Zhang, Beijing (CN); Zaiping Feng, Beijing (CN)

Correspondence Address: William P. Glenn, Jr., Suite 205, 2102 Mechanic Street, Galveston, TX, 77550, US

(21) Appl. No.: 11/073,502

(22) Filed: Mar. 4, 2005

(51) Int. Cl. B60R 1/12; B60Q 1/26

(52) U.S. Cl. 362/494

(57) ABSTRACT

An improved multifunction mirror display system that combines the display of projected and reflected data in a single console by compressively coupling, without the use of adhesives, a reflective element (e.g. two-way mirror) with an emitting element (e.g. a liquid crystal display) within a housing. Compressive coupling of a reflective element with an emitting element is achieved by urging: (1) a reflective element against an emitting element; (2) an emitting element against a reflective element; or (3) both a reflective element and an emitting element against one another. Such an improved multifunction mirror display system can be used with overland, air, water and/or amphibious vehicles, buildings or non-occupied structures like sign posts, bridges and/or guard rails.

### TECHNICAL FIELD

The present invention relates generally to mirror technology. More specifically the present invention relates to semi-reflective or two-way mirror technology that allows reflected and projected images to be viewed from a mirror panel.

### BACKGROUND ART

Mirrors both for use in vehicles (like cars, trucks, airplanes, and vessels) and in/on structures (like houses, buildings and sign posts) are used to enable a person to observe a reflected image of an object not within the person's direct line of sight. Such mirrors are an every day tool to provide data in the form of visual images of objects not within the person's direct line of sight. Likewise, a person in a vehicle or building or next to a sign post may require additional useful information that can be readily presented in a visual manner such as environmental or operational data.

As recognized by the present invention, it can be advantageous to combine visual data sources not only to realize savings related to manufacturing costs, but also to promote safe, efficient and/or effective data presentation. The present invention recognizes that data presented on a mirror may be more accessible than data presented in separate displays that would not otherwise attract the person's attention as much as a multifunction mirror display.

The present multifunction mirror display invention achieves the desirable goal of combining the display of projected and reflected data in a single console without permanently sacrificing a portion of the reflective element or increasing the overall viewing area to present projected data.

As further recognized by the present invention, the advantage of a combined or multifunction display is achieved by coupling an emitting display to a reflective display without the use of adhesives or a complicated and expensive manufacturing process to couple the emitting and reflective displays.

As still further recognized by the present invention, the advantage of reducing heat buildup of an emitting element (or visual display) is achieved by coupling an emitting element (or visual display) to a reflective element (or visual display) without the use of adhesives.

As still further recognized by the present invention, it is desirable to have a multifunction mirror system that allows the replacement of individual display elements (reflective and/or emitting) when damage or inoperable. Furthermore as recognized herein, it is desirable to have a multifunction mirror system that allows an upgrade or change of display elements (reflective and/or emitting).

Accordingly, it is an object of the present invention to provide a person with a multifunction mirror display system which combines the display of reflected and projected data from a mirror display. Another object of the invention is to achieve coupling of a reflective element, like a mirror, with an emitting element, like a video display, without the use of adhesives. Still another object of the invention is to provide a multifunction mirror system that is easy to manufacture. Yet another object of the invention is to provide a multifunction mirror display that reduces heat buildup of an emitting element (or video display) by eliminating the need for an adhesive to fix an emitting element with or to a reflective element. Still yet another object of the invention is to provide a multifunction mirror display that allows inexpensive repairs or replacements of damaged, inoperable or obsolete display components to be performed without highly skilled labor. Yet another object of the invention is to provide a multifunction mirror display that is easy to use.

### SUMMARY OF INVENTION

The present invention in its several disclosed embodiments alleviates the drawbacks and deficiencies described above with respect to existing multifunction mirror display systems. The present invention incorporates several additionally beneficial features.

The improved multifunction mirror display system achieves the goal of combining the display of projected and reflected data in a single console by compressively coupling, without the use of adhesives, a reflective element (e.g. two-way mirror) with an emitting element (e.g. a liquid crystal display) within a housing. Compressive coupling of a reflective element with an emitting element is achieved by urging: (1) a reflective element against an emitting element; (2) an emitting element against a reflective element; or (3) both a reflective element and an emitting element against one another.

In a preferred embodiment, a removable frame, fixed in a predetermined and repeatable orientation within a housing, achieves compressive coupling by at least one pair of opposing tabs on the frame in biased contact with an emitting element to urge the emitting element against a reflective element affixed to the housing. In another embodiment, a bezel, removeably fixed in a predetermined and repeatable orientation to a housing, achieves compressive coupling by at least one pair of opposing leaves on the bezel in biased contact with a reflective element to urge the reflective element against an emitting element fixed in a housing. In yet another embodiment, a support panel accomplishes compressive coupling by situating an axially resilient member between a housing and a support panel to urge an emitting element (fixed to the support panel) against a reflective element fixed to the housing. In still another preferred embodiment, any combination of the above embodiments can be combined to achieve compressive coupling.

The improved multifunction mirror display system achieves the goal of low cost manufacturing, reduced heat buildup, repairs and/or upgradeability by removeably fixing an emitting element in and/or a reflective element to a housing in pre-determined positions for compressive coupling with each other. This goal is also achieved by the present invention by using a universal signal and power harness between an emitting display (and certain reflective elements), a signal source and power source.

The present invention in achieves the goal of simple and low cost manufacturing by positioning a reflective element on and an emitting element in a housing without the use of adhesives. The present invention further achieves the goal of inexpensive repairs and upgrades of a reflective element and/or an emitting element by incorporating a universal signal and power harness between a signal source and emitting display as well as eliminating the need for adhesives to couple a reflective element and an emitting element.

The present invention also achieves the goal of reducing heat buildup of a visual display by eliminating the need for adhesives to couple a visual display to a reflective display by compressively coupling a visual display to a reflective display.

Furthermore, the present invention in each of the embodiments discussed herein achieves the goal of interchangeability for repair, upgrade or change in display types by removeably fixing a reflective element on a housing and removeably fixing an emitting element in a housing and a universal signal and power harness.

### BRIEF DESCRIPTIONS OF THE DRAWINGS

The invention is described in greater detail in the following examples and with reference to the attached drawings, in which:

FIG. 1 is a schematic and cut away view of a multifunction mirror for a vehicle.

FIG. 2 is a schematic and cut away view of a multifunction mirror for a building.

FIG. 3 is a cross sectional cutaway view of a multifunction mirror for a non-occupied structure.

FIG. 4 is an exploded view of a multifunction mirror display having a frame with tabs to compressively couple an emitting element with a reflective element.

FIG. 5 is a cross sectional cutaway view of a multifunction mirror display depicted in FIG. 1.

FIG. 6 is an exploded view of a multifunction mirror display having a frame with another embodiment of tabs to compressively couple an emitting element with a reflective element.

FIG. 7 is an exploded view of a multifunction mirror display having a bezel with one embodiment of leaves to compressively couple an emitting element with a reflective element.

FIG. 8 is a cross sectional cutaway view of a multifunction mirror display having another embodiment of a bezel with leaves to compressively couple an emitting element with a reflective element.

### DETAILED DESCRIPTION OF THE INVENTION

GENERAL OVERVIEW: As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and function details disclosed herein are not be interpreted as limiting, but merely as a basis for the claims and as a representative basis for teaching one skilled in the art to variously employ in the present invention.

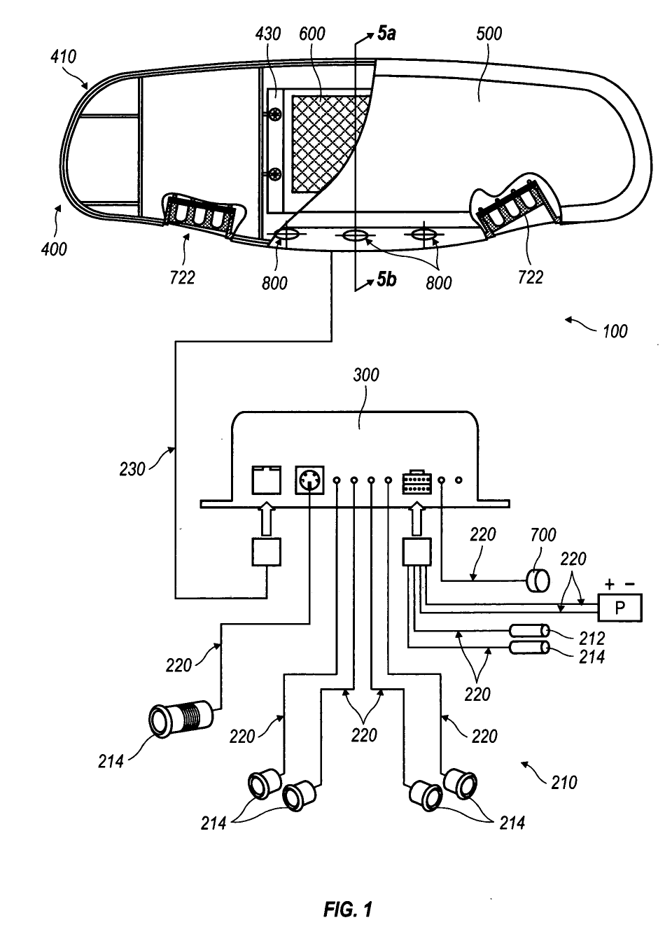

As depicted in FIG. 1, a preferred embodiment of the present invention is directed toward a multifunction mirror display system 100 for a vehicle that includes an information console assembly 400 having an emitting element 600 in a pre-determined orientation in a housing 410. An emitting element 600 of the present invention is compressively coupled to a reflective element 500 in a pre-determined orientation to a housing 410. A processor unit 300 is in communication between an emitting element 600 and an information input system 210. An emitting element 600 can be a visual display 610 (as shown in FIG. 3) that emits radiation detectible by an operator or an emitter of infrared and/or ultraviolet radiation detectable by sensors adapted to receive such radiation. Data is collected or sensed by an information input system 210 for input to a processor unit 300. After manipulation of data received from an information input system 210, processor unit 300 communicates a signal to an emitting element 600. It is contemplated that a multifunction mirror display system 100 of the present invention can be used with a variety of vehicles, including but not limited to over land craft (e.g. cars, trucks, motorcycles, etc.), marine craft (e.g. ships, boats, submarines, etc.), aircraft (e.g. planes, balloons, gliders, etc.), and amphibious craft (such as hovercraft).

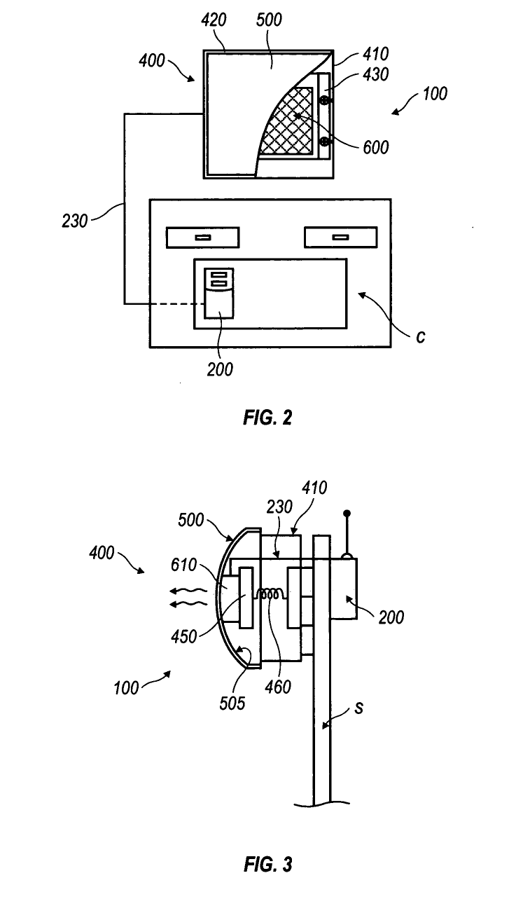

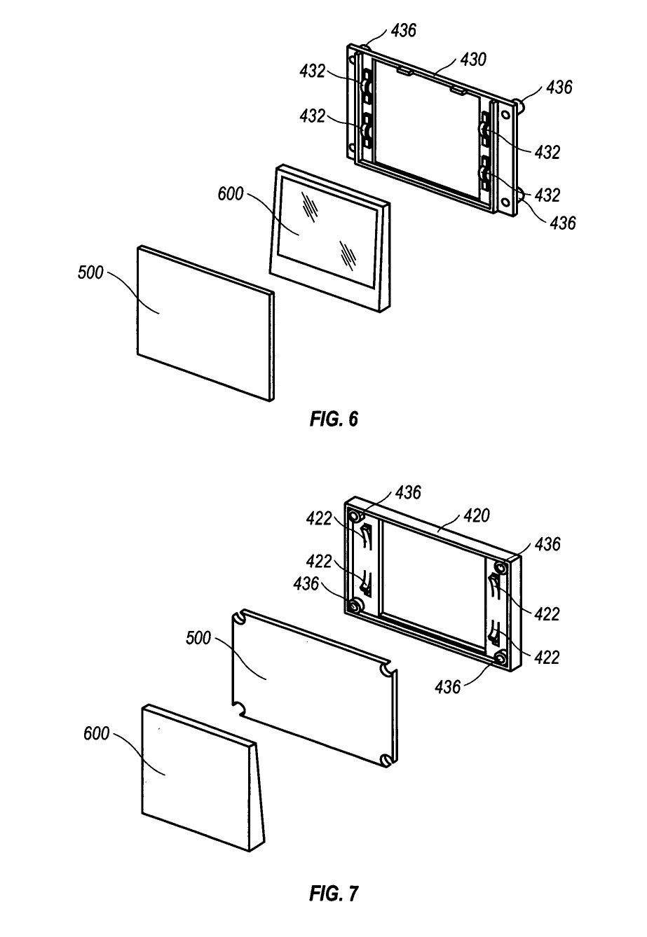

FIG. 2 depicts another embodiment of the present invention, namely a multifunction mirror display system 100 that includes an information console assembly 400 having a housing 410, a frame 430, a reflective element 500, such as a two-way mirror panel, removeably (or permanently) fixed to the housing 410. Frame 430 comprises at least one pair of opposing tabs 432 (See FIG. 6) in bias contact with an emitting element 600 to compressively couple the emitting element 600 to a reflective element 500. A signal source 200 is in communication with a emitting element 600 through a universal signal and power harness 230. In another embodiment, a multifunction mirror display system 100 can be attached to a vehicle, building or unoccupied structures like a stand, sign, light post, guard rails and/or bridges. As shown in FIG. 2, multifunction mirror display 100 is fixed above a counter C in a building.

FIG. 3 depicts another embodiment of the present invention, namely a multifunction mirror display system 100 that includes an information console assembly 400 having a housing 410, a support panel 450, an axially resilient member 460, a visual display 610 and a reflective element 500, like a two-way mirror panel. Visual display 610 is removeably (or permanently) fixed to a support panel 450 and a reflective element 500 is removeably (or permanently) fixed to a housing 410. Compressive coupling of a reflective element 500 and a visual display 610 is achieved by an axially resilient member 460 disposed between a support panel 450 and a housing 410. Visual display 610 is in communication with a signal source 200. Signal source 200 can be an information input system 210 (as depicted in FIG. 1) or any device that can generate a signal that can be utilized by an emitting element 600. As shown in FIG. 3, multifunction mirror display 100 includes a curved reflective element 500 compressively coupled with a visual display 610 that is fixed to an unoccupied structure, namely a sign post S. As represented in FIG. 3, signal source 200 is a wireless receiver that provides a signal to a visual display 610 through a universal signal and power harness 230.

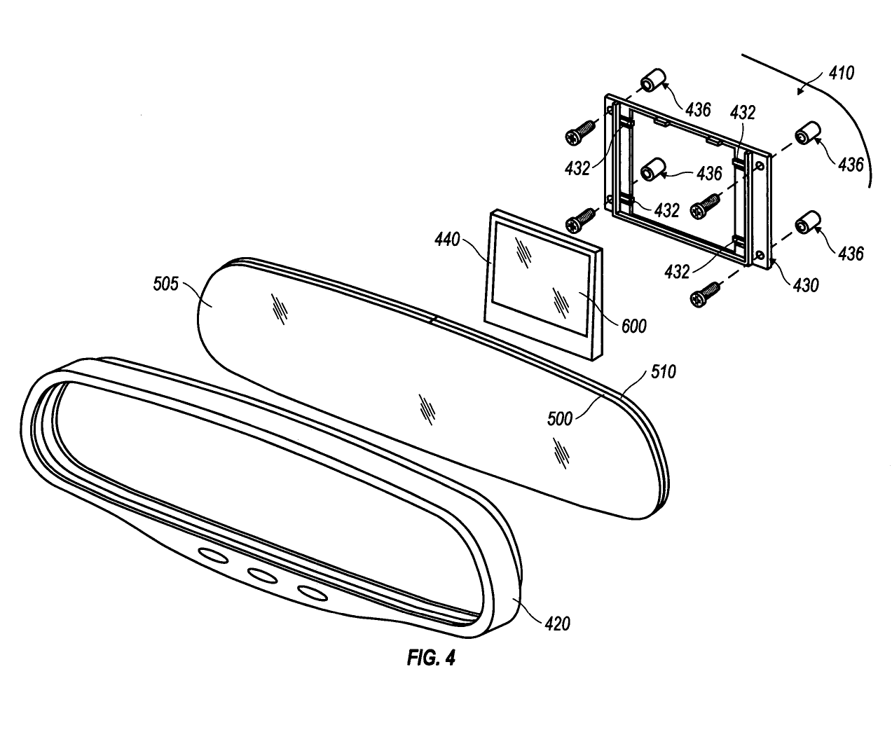

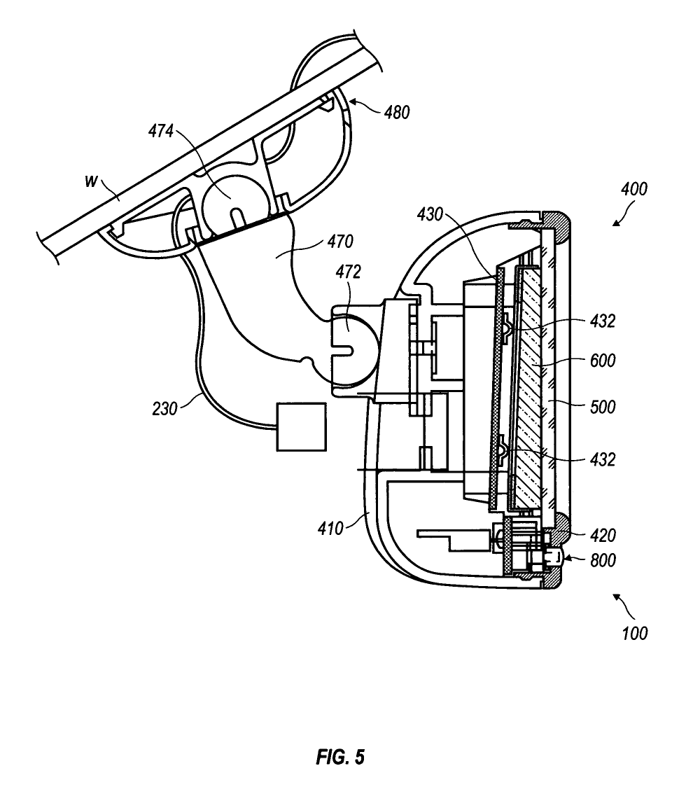

Reflective element 500 is fixed in a pre-determined orientation to a housing 410 to reflect between approximately 10% and 90% of light (visible and/or infrared) generated by an exterior light source and pass approximately 10% to 90% of light (visible and/or infrared) of light (visible and/or infrared) generated by an emitting element 600 compressively coupled to the reflective element 500 (See FIGS. 4 and 5).

Reflective element 500 can have a panel form with flat, concave and/or convex opposing surfaces 505 (See FIGS. 3 and 4). The shape of a surface 505 is dependent primarily upon the desired reflected image. Furthermore, the outline of a reflective element 500 can be polygonal, circular, arcuate or a combination thereof. Reflective element 500 is manufactured from glass, plastic, or other transparent materials. At least one surface 505 of a reflective element 500 is covered (in whole or in part) by a reflective layer 510 (See FIG. 4). The processes by which a reflective layer 510 covers a surface 505 are well known to those skilled in such arts. In a preferred embodiment, reflective layer 510 includes at least one metal material. In another preferred embodiment, reflective layer 510 is at least one metal material selected from the group consisting of chromium, silver, titanium, aluminum or a combination thereof. In another preferred embodiment, metal material is deposited by a pyrolitic process to a thickness of between approximately 0.001 millimeters and approximately 0.08 millimeters on a surface 505 of a reflective element 500. The total thickness of reflective element 500 and reflective layer 510 together ranges between about 0.01 millimeters to about 50 millimeters. As can be appreciated, the reflective layer 510 may be altered in materials as well as thickness to obtain specific performance criteria.

In a preferred embodiment, emitting element 600 is a visual display 610 which projects visible light through a reflective element 500 and away from a housing 410 (See FIGS. 3 and 5). In another embodiment, emitting element 600 projects infrared and/or ultraviolet light through a reflective element 500 and away from a housing. In yet another embodiment, visible, ultraviolet and/or infrared light is projected through a reflective element 500 and away from a housing 410. It is contemplated in a preferred embodiment, that an emitting element 600 be at least one visual display 610 selected from the group consisting of a liquid crystal display, a vacuum fluorescent display, a light emitting diode display, a plasma display panel, a field emission display, an organic electroluminescent display, an inorganic electroluminescent display, and a combination thereof. The construction, power consumption and workings of an emitting element 600 are known to those skilled in such arts.

For use with a vehicle, emitting element 600 is a visual display 610 that can be as small as about 5 millimeters×about 3 millimeters×about 0.001 millimeters and as big as about 2500 millimeters×about 2000 millimeters×about 1000 millimeters, with a preferred size of about 60 millimeters×about 20 millimeters×about 10 millimeters. In a preferred embodiment for attachment to an overland vehicle, visual display 610 is a liquid crystal display with a viewing angle of about 90 to about 180 degrees horizontally and about 50 to about 180 degrees vertically. In a preferred embodiment for use in a building or mounted to a non-occupied structure, emitting element 600 can be as small as about 0.5 centimeters×about 0.01 centimeters×about 0.0001 centimeters and as big as about 2000 centimeters×about 1500 centimeters×about 300 centimeters.

As depicted in FIGS. 4 through 6, compressively coupling of an emitting element 600 to a reflective element 500 is achieved by opposing tabs 432 of a frame 430 in biased contact with the emitting element 600 to urge the emitting element 600 against the reflective element 500. Reflective element 500 can be removeably fixed to housing 410 by a bezel 420 (See FIGS. 2, 4 and 5) or more traditional fastening means such as mirror holders (not shown).

Frame 430 of the present invention is manufactured from ferrous metals, non-ferrous metals, plastics, composite materials or a combination thereof with sufficient dimensions to hold an emitting element 600 in a pre-determined attitude and position within a housing 410. Opposing tabs 432 are manufactured from ferrous metals, non-ferrous metals, plastics, composite materials or a combination thereof with sufficient dimensions and resiliency to engage in bias contact with a portion of an emitting element 600 to urge the emitting element 600 against an adjacent reflective element 500 removeably fixed to a housing 410. In a preferred embodiment, opposing tabs 432 are formed out of the same material as a frame 430 and are fixed at one end the frame 430 (See FIG. 4). In another embodiment, opposing tabs 432 are formed out of a different material as a frame 430 and are fixed to a frame 430 by fixing opposing ends of each tab 432 to frame 430 (See FIGS. 5 and 6).

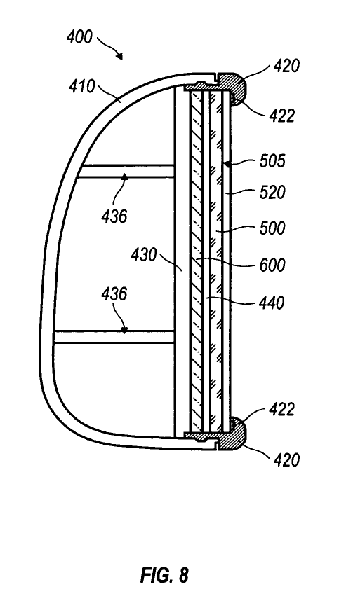

In another embodiment of the present invention, as depicted in FIGS. 7 and 8), compressive coupling is achieved with a bezel 420 removeably fixed to a housing 410 (not shown in FIG. 7). Bezel 420 having at least one pair of opposing leaves 422 in biased contact with a reflective element 500 to urge the reflective element 500 against the emitting element 600. In such an embodiment, emitting element 600 is removeably fixed to a housing 410. Bezel 420 is manufactured from a ferrous metal, a non-ferrous metal, a plastic, a composite material or a combination thereof with sufficient dimensions to hold a reflective element 500 in a pre-determined attitude and position affixed to a housing 410. Opposing leaves 422 are manufactured from a ferrous metal, a non-ferrous metal, a plastic, a composite material or a combination thereof with sufficient dimensions and resiliency to engage in bias contact with a portion of a reflective element 500 to urge the reflective element 500 against an adjacent emitting element 600 removeably fixed in a housing 410. In a preferred embodiment, opposing leaves 422 are formed out of the same material as a bezel 420 and are fixed at one end to bezel 420 (See FIG. 7). In another embodiment, opposing leaves 422 are formed out of a different material as a bezel 420 and are fixed to a bezel 420 by fixing opposing ends of each leave 422 to bezel 420, similar to fixation of tabs 432 to a frame 430 as shown in FIG. 6.

In yet another embodiment of the present invention, an information console assembly 400 comprises an axially resilient member 460 disposed between a housing 410 and a support panel 450. Support panel 450 holds an emitting element 600 at a pre-determined position and orientation with a housing 410. Axially resilient member 460 urges said emitting element 600 against a reflective element 500 removeably affixed to a housing 410 to achieve compressive coupling between the two elements 500, 600.

It is contemplated that a support panel 450 can be manufactured from a ferrous metal, a non-ferrous metal, a plastic, a composite material or a combination thereof with sufficient dimensions and strength to hold an emitting element 600 and further transmit the compressive force from an axially resilient member 460 to the emitting element 600 to achieve compressive coupling between the reflective and emitting elements 500, 600.

Axially resilient member 460 is manufactured from a ferrous metal, a non-ferrous metal, a plastic, a composite material or a combination thereof with sufficient dimensions and force to compressively couple an emitting element 600 to a reflective element 500 without deforming a housing 410, support panel 450, emitting display 600 and/or reflective element 600 or causing reflective element 600 from detaching from housing 410. One embodiment of an axially resilient member 460 includes a spring, a compressed gas cylinder or a combination thereof.

In a preferred embodiment, a spacer sheet 440 is disposed between a reflective element 500 and a peripheral region of an emitting element 600 which are compressively coupled to each other (Sees FIGS. 4 and 8). Spacer sheet 440 is formed from a flexible material that enhances compressive coupling between a reflective element 500 and an emitting element 600 as well as reducing the amount of light (visual, ultraviolet and/or infrared) that may leak out from such a coupling due to irregularities. In a preferred embodiment, spacer sheet 440 is made from polyurethane with a thickness of about 0.01 to about 15 millimeters.

In a preferred embodiment, a binding layer 520 is affixed to a portion of a surface 505 to strengthen a reflective element 500; at least reduce the possibility of failure; and further retain broken pieces of said reflective element 500 if failure does occur (See FIG. 8). In a preferred embodiment, binding layer 520 is transparent to radiation emitted from said emitting element 600.

As described above, a processor unit 300 is in communication between an emitting element 600 and an information input system 210. Data is collected or sensed by an information input system 210 for input to a processor unit 300. After manipulation of data received from an information input system 210, processor unit 300 communicates a signal to an emitting element 600 (See FIG. 1).

In a preferred embodiment, information input system 210 includes at least one environmental sensor 212 or operational sensor 214 (See FIG. 1). It is contemplated that an environmental sensor 212 is a temperature sensor, a relative humidity sensor, a barometric pressure sensor, a carbon monoxide sensor, a carbon dioxide sensor, an ambient light sensor, a relative wind speed sensor or a combination thereof. In another embodiment, an operational sensor 214 is a video camera, clock, odometer, compass, speed sensor, global positioning sensor, distance to obstruction sensor, direction sensor or a combination thereof.

Information input system 210 further includes a universal input and power harness 220 removeably connected between a power source P, an environmental sensor 212 (or an operational sensor 214) and a processor unit 300 (See FIG. 1). Universal input and power harness 220 can be a traditional point to point harness capable of communicating signals (electrical or light) between a sensor 212 (or 214) and a processor unit 300. It is further contemplated that a universal input and power harness 220 can be daisy chained to allow communication from a sensor 212 (or 214) to a processor unit 300 via another sensor or sensors 212 (or 214). In a preferred embodiment, universal input and power harness 220 is manufactured from traditional wire used for communicating electrical signals. In another embodiment, universal input and power harness 220 is manufactured in part from fiber optic materials. Universal input and power harness 220 is configured with sufficient physical size and capacity to carry and/or communicate a wide variety of signals and/or electrical current between a processor unit 300 and interchangeable sensors 212 (and/or 214) as well as the power demands of a sensor 212 (or 214) or plurality of sensors 212, 214.

In a preferred embodiment, an information console assembly further includes a universal signal and power harness 230 removeably connected between a processor unit 300 and an emitting element 600 (See FIG. 1). In a preferred embodiment, universal signal and power harness 230 is manufactured from traditional wire used for communicating electrical signals. In another embodiment, universal signal and power harness 230 is manufactured in part from fiber optic materials. Universal signal and power harness 230 is configured with sufficient physical size and capacity to carry and/or communicate a wide variety of signals between a processor unit 300 and interchangeable emitting elements 600 as well as the power demands of an emitting element 600.

Processor unit 300 receives and processes signals from an information input system 210. In another embodiment, processor unit 300 alters the operational state of an emitting element 600 when data collected from an information input system 210 is compared against pre-determined values. For example, if an information input system 210 includes an operational sensor 214, like a vehicle direction sensor, and a signal collected indicate the vehicle is to be(or is) traveling in reverse, then processor unit 300 turns on emitting element 600 to display signals from another operational sensor(s) 214, like a video camera and/or distance and proximity sensor.

In another embodiment, processor unit 300 alters the operational state of an alarm 700 when data collected from an information input system 210 is compared against pre-determined values (See FIG. 1). Alarm 700 can be aural and/or visual. For example, if an information input system 210 includes an operational sensor 214, like a vehicle direction sensor, and a signal collected indicate the vehicle is to be(or is) traveling in reverse, then processor unit 300 activates alarm 700. It is further contemplated that processor unit 300 may alter the tone (for aural alarms) or light characteristics (color, intensity and/or state—flashing) of an alarm 700 depending on the results of the data comparison in processor unit 300. In a preferred embodiment, alarm 700 is a reading light 722 mounted in a housing 410. The operational state of reading light 722 is further altered by a keypad or switch 800. Switch 800 can be mounted in a housing 410 (See FIGS. 1 and 5) and/or a door (not shown).

Housing 410 includes a standardized pattern of frame mounts 436 extending from the housing 410 for removeable fixation of a frame 430 (See FIG. 4). A standardized pattern of frame mounts 436 provides the flexibility of mounting a variety of frames 430 to achieve compressive coupling between a variety of emitting elements 600 with a reflective element 500. Such a preferred embodiment of the present invention lowers manufacturing and repair costs. It also provides an upgrade path for an emitting element 600 or the option of changing the type of emitting element 600 to be compressively coupled to a reflective element 500.

Housing 410 and frame mounts 436 may be manufactured from a ferrous metal, a non-ferrous metal, a plastic, a composite material or a combination thereof with sufficient dimensions and stability to securely mount components of an information console assembly 400 and withstand forces associated with compressive coupling of an emitting element 600 with a reflective element 500. The size and shape of a housing 410 is dependent primarily upon the intended use of a multifunction mirror display 100. In a preferred embodiment for use with an overland vehicle such as a car, housing 410 is approximately 5 to approximately 100 centimeters×approximately 1 to approximately 60 centimeters×approximately 0.001 to approximately 5 centimeters. In a preferred embodiment for use in a building, housing 410 is approximately 1 to approximately 2000 centimeters×approximately 1 to approximately 1500 centimeters×approximately 0.001 to approximately 300 centimeters.

Mounting of a multifunction mirror display 100 can be done in a variety of ways. When used with a vehicle, an arm 470 is adapted to mount a housing 410 to a vehicle (See FIG. 5). In one embodiment, housing 410 is pivotally mounted to an arm 470. In another embodiment, arm 470 includes dual ball joints 472, 474 (See FIG. 5). This allows a portion of a multifunction mirror display to be positioned in a variety of orientations for an operator. In yet another embodiment, information console assembly 400 further includes a mount base 480 adapted for attachment to a portion of a vehicle. Mount base 480 can be further adapted for attachment to a portion of a vehicle's windshield W or a mirror mounting button (not shown).

A multifunction mirror display 100 and its components have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

What is claimed and desired to be secured by Letters Patent is as follows:

1. A multifunction mirror display system for a vehicle, said multifunction mirror display system comprising:
an information console assembly having an emitting element in a pre-determined orientation in a housing, said emitting element compressively coupled to a reflective element in a pre-determined orientation to said housing to reflect between approximately 10% and 90% of light generated by a light source exterior to said housing and transmit away from said housing between approximately 10% and 90% of radiation generated by said emitting element; and
a processor unit in communication between said emitting element and an information input system, said information input system collects data for input to said processor unit, and said processor unit manipulates said data and communicates a signal to said emitting element.

2. A multifunction mirror display system for a vehicle as claimed in claim 1, wherein said information console assembly further comprises a frame removeably fixed in said housing, said frame having at least one pair of opposing tabs in biased contact with said emitting element to urge said emitting element against said reflective element removeably affixed to said housing to achieve said compressive coupling.

3. A multifunction mirror display system for a vehicle as claimed in claim 2, wherein a tab of said pair of tabs is fixed at one end to said frame.

4. A multifunction mirror display system for a vehicle as claimed in claim 2, wherein a tab of said pair of tabs is fixed at opposing ends to said frame.

5. A multifunction mirror display system for a vehicle as claimed in claim 1, wherein said information console assembly further comprises a bezel removeably fixed to said housing, said bezel having at least one pair of opposing leaves in biased contact with said reflective element to urge said reflective element against said emitting element fixed in said housing to achieve said compressive coupling.

6. A multifunction mirror display system for a vehicle as claimed in claim 5, wherein a leaf of said pair of leaves is fixed at one end to said bezel.

7. A multifunction mirror display system for a vehicle as claimed in claim 5, wherein a leaf of said pair of leaves is fixed at opposing ends to said bezel.

8. A multifunction mirror display system for a vehicle as claimed in claim 1, wherein said information console assembly further comprises a support panel, and an axially resilient member; said support panel holds said emitting element within said housing and said axially resilient member is disposed between said housing and said support panel to urge said emitting element against said reflective element affixed to said housing to achieve said compressive coupling.

9. A multifunction mirror display system for a vehicle as claimed in claim 8, wherein said information console further comprises a bezel removeably fixed to said housing, said reflective element positioned in said bezel.

10. A multifunction mirror display system for a vehicle as claimed in claim 1, wherein a spacer sheet is disposed between said reflective element and a peripheral region of said emitting element to enhance said compressive coupling.

11. A multifunction mirror display system for a vehicle as claimed in claim 1, wherein said reflective element further comprises a reflective layer of chromium covering a surface of said reflective element.

12. A multifunction mirror display system for a vehicle as claimed in claim 11, wherein a binding layer is affixed to a portion of a planar surface of said reflective element, said binding layer strengthens and at least reduces the possibility of said reflective element failing and further retains broken pieces of said reflective element if failure does occur.

13. A multifunction mirror display system for a vehicle as claimed in claim 12, wherein said binding layer is generally transparent to radiation emitted from said emission element.

14. A multifunction mirror display system for a vehicle as claimed in claim 1, wherein said emitting element is at least one visual display selected from the group consisting of a liquid crystal display, a vacuum fluorescent display, a light emitting diode display, a plasma display panel, a field emission display, an organic electroluminescent display, and an inorganic electroluminescent display.

15. A multifunction mirror display system for a vehicle as claimed in claim 1, wherein said information input system is at least one environmental sensor selected from the group consisting of a temperature sensor, a relative humidity sensor, a barometric pressure sensor, a carbon monoxide sensor, a carbon dioxide sensor, an ambient light sensor, and relative wind speed sensor.

16. A multifunction mirror display system for a vehicle as claimed in claim 15, wherein said environmental sensor is positioned within said housing.

17. A multifunction mirror display system for a vehicle as claimed in claim 15, wherein said environmental sensor is positioned on the vehicle.

18. A multifunction mirror display system for a vehicle as claimed in claim 15, wherein said environmental sensor is remotely positioned to said vehicle.

19. A multifunction mirror display system for a vehicle as claimed in claim 15, wherein said information input system further comprises a universal input and power harness removeably connected between said environmental sensor and said processor unit.

20. A multifunction mirror display system for a vehicle as claimed in claim 1, wherein said information input system is at least one vehicle operational sensor selected from the group consisting of a video camera, clock, odometer, compass, speed sensor, global positioning sensor, distance to obstruction sensor, and direction sensor.

21. A multifunction mirror display system for a vehicle as claimed in claim 20, wherein said information input system further comprises a universal input and power harness removeably connected between said vehicle operational sensor and said processor unit.

22. A multifunction mirror display system for a vehicle as claimed in claim 1, wherein said information console assembly further comprises a universal signal and power harness removeably connected between said processor unit and said emitting display.

23. A multifunction mirror display system for a vehicle as claimed in claim 1, wherein an operational state of said emitting element is altered by said processor when said data is compared against pre-determined values.

24. A multifunction mirror display system for a vehicle as claimed in claim 1, wherein an operational state of an alarm is altered by said processor when said data is compared against pre-determined values.

25. A multifunction mirror display system for a vehicle as claimed in claim 24, wherein said alarm is aural.

26. A multifunction mirror display system for a vehicle as claimed in claim 24, wherein said alarm is visual.

27. A multifunction mirror display system for a vehicle as claimed in claim 24, wherein said alarm is a reading light located in said housing and an operational state of said reading light is altered by a manually operated keypad positioned on said housing.

28. A multifunction mirror display system for a vehicle as claimed in claim 1, wherein said information console assembly further comprises an arm adapted for mounting to a portion of a vehicle, said housing pivotally mounted to said arm.

29. A multifunction mirror display system for a vehicle as claimed in claim 28, wherein said arm comprises a dual ball joint support.

30. A multifunction mirror display system for a vehicle as claimed in claim 1, wherein said information console assembly further comprises a mount base adapted for attachment to a portion of the vehicle.

31. A multifunction mirror display system for a vehicle as claimed in claim 30, wherein said mount base is adapted for attachment to a portion of the vehicle's windshield.

32. A multifunction mirror display system for a vehicle as claimed in claim 30, wherein said mount base is adapted for attachment to a mirror mounting button.

33. A multifunction mirror display system, said multifunction display system comprising:
an information console assembly having a housing, frame, two-way mirror panel and visual display, said two-way mirror panel removeably fixed to said housing, said frame comprises at least one pair of opposing tabs in bias contact with said visual display, and said visual display compressively coupled to said two-way mirror by said frame; and
a signal source in communication with said visual display.

34. A multifunction mirror display system as claimed in claim 33, wherein said information console assembly further comprises a bezel removeably fixed to said housing, said two-way mirror panel positioned in said bezel.

35. A multifunction mirror display system as claimed in claim 33, wherein said two-way mirror reflects between approximately 10% and 90% of light generated by a light source exterior to said housing and transmits between approximately 10% and 90% of light emitted from said visual display.

36. A multifunction mirror display system as claimed in claim 33, wherein a binding layer is affixed to a portion of said two-way mirror panel, said binding layer strengthens and at least reduces the possibility of said two-way mirror panel failing and further retains broken pieces of said two-way mirror panel if failure does occur.

37. A multifunction mirror display system as claimed in claim 36, wherein said binding layer is generally transparent to the light emitted from said visual display.

38. A multifunction mirror display system as claimed in claim 33, wherein a universal signal and power harness effects said communication between said signal source and said video display.

39. A multifunction mirror display system as claimed in claim 33, wherein a universal signal and power harness effects said communication between said signal source and said visual display.

40. A multifunction mirror display as claimed claim 33, wherein said information console assembly is attached to a vehicle.

41. A multifunction mirror display system, said multifunction display system comprising:
an information console assembly having a housing, a support panel, an axially resilient member, a two-way mirror panel and a visual display; wherein said visual display is fixed to said support panel, said two-way mirror panel is fixed to said housing, and said axially resilient member is disposed between said housing and said support panel to compressively couple said visual display to said two-way mirror panel; and
a signal source in communication with said visual display.

42. A multifunction mirror display system as claimed in claim 41, wherein an axially resilient member is a spring.

43. A multifunction mirror display system as claimed in claim 41, wherein said axially resilient member is a compressed gas cylinder.

44. A multifunction mirror display system as claimed in claim 41, wherein said two-way mirror further comprises a reflective layer, wherein said reflective layer is at least one metal material that reflects between approximately 10% and 90% of light generated by a light source exterior to said housing and transmits between approximately 10% and 90% of light emitted from said visual display.

45. A multifunction mirror display system as claimed in claim 41, wherein a binding layer is affixed to a portion of said two-way mirror panel, said binding layer strengthens and at least reduces the possibility of said two-way mirror panel failing and further retains broken pieces of said two-way mirror panel if failure does occur.

46. A multifunction mirror display system as claimed in claim 45, wherein said binding layer is generally transparent to the light emitted from said visual display.

47. A multifunction mirror display system as claimed in claim 41, wherein said information console assembly is attached to a vehicle.
